(19) United States
(12) Patent Application Publication
(10) Pub. No.: US 2022/0250154 A1
(43) Pub. Date: Aug. 11, 2022

(54) ADDITIVE MANUFACTURING

(71) Applicant: ADDITIVE MANUFACTURING TECHNOLOGIES LIMITED, Sheffield (GB)

(72) Inventors: Joseph Gwilliam Crabtree, Sheffield (GB); Konstantin Rybalcenko, Sheffield (GB); Andre Gaio, Sheffield (GB)

(73) Assignee: ADDITIVE MANUFACTURING TECHNOLOGIES LIMITED, Sheffield (GB)

(21) Appl. No.: 17/596,158

(22) PCT Filed: Jun. 9, 2020
(86) PCT No.: PCT/GB2020/051391

§ 371 Date: Dec. 3, 2021

(30) Foreign Application Priority Data
Jun. 10, 2019 (GB) 1908244.5

(51) Int. Cl. B22F 10/50; B33Y 10/00; B33Y 30/00; B22F 10/10; B22F 10/64; B33Y 40/20

(52) U.S. Cl. CPC B22F 10/50; B33Y 10/00; B33Y 40/20; B22F 10/10; B22F 10/64; B33Y 30/00

(57) ABSTRACT

According to the present disclosure, there is provided a method for smoothing a surface of an additively manufactured metal part. The method comprises applying a chemical to a stepped surface of an additively manufactured part to at least soften a binder material supporting unprocessed powder particles of the part and allowing the powder particles at the surface to flow under the influence of gravity into recesses defined by the stepped surface to thereby reduce a roughness of the surface. Advantageously, it has been found that the afore-described method is able to provide a part having an improved surface smoothness.

The present invention relates to additive manufacturing and in particular, but not exclusively, to post-processing of additively manufactured metal components.

Additive manufacturing (AM) is a process during which an object can be manufactured from a digital file using a layer-by-layer method. Fused Filament Fabrication (FFF) also called Fused Deposition Modelling (FDM) is a frequently used AM process during which heated material in the form of a paste is extruded through a printer nozzle to form a desired 3D shape. A variation of this technology involves the use of a metallic powder for sintering and a binder material, typically a polymer, for retaining the shape of the metallic powder during the extrusion process. In addition, a ceramic or other material interface layer may be used to support overhanging part structures while they are being printed.

Once the metallic powder together with the polymer binder are extruded to form a part, the part is in a so-called “green” state and requires de-binding and thermal post-processing. The de-binding process uses a solvent to dissolve a majority of the binder material supporting the metallic powder. During thermal post-processing, the metallic powder sinters together to form the final part whilst any remaining binder material is vaporised. The metallic powder may include two or more metals selected to form an alloy during the thermal post-processing stage.

However, the layer-by-layer nature of the FFF/FDM printing process results in a stepped surface which is undesirably rough and can promote cracking in use.

It is an aim of certain embodiments of the present invention to provide a method of post-processing an additively manufactured metal part to provide the part with a relatively smooth outer surface.

According to a first aspect of the present invention there is provided a method for smoothing a surface of an additively manufactured metal part, comprising:
applying a chemical to a stepped surface of an additively manufactured part to at least soften a binder material supporting unprocessed powder particles of the part; and
allowing the powder particles at the surface to flow under the influence of gravity into recesses defined by the stepped surface to thereby reduce a roughness of the surface.

In exemplary embodiments, the method comprises applying a chemical to a stepped surface of an additively manufactured part to at least soften a binder material supporting unprocessed powder particles of the part, but so as not to soften the powder particles of the part.

In other words, the powder particles comprise a material resistant to the chemical.

In exemplary embodiments, the method comprises allowing the binder material to cure and support the powder particles at the surface.

In exemplary embodiments, the method comprises thermally treating the part to remove the binder material from the part.

In exemplary embodiments, thermally treating comprises vaporising the binder material.

In exemplary embodiments, the method comprises sintering the part to fuse the powder particles together.

In exemplary embodiments, the method further comprises allowing the binder material to cure and support the powder particles at the surface of the part and sintering the part to fuse the powder particles of the part together, wherein, during sintering, the binder material is vaporised and removed from the part.

In exemplary embodiments, the method comprises drying the part to remove the chemical from the surface.

In exemplary embodiments, applying comprises vaporising the chemical and condensing the chemical on to the surface of the part.

In exemplary embodiments, vaporising comprises heating the chemical in a liquid state to a predetermined temperature.

In exemplary embodiments, condensing comprises creating an energy potential between the part and the vaporised chemical.

In exemplary embodiments, the method comprises cooling the part to create the energy potential and cause the vaporised chemical to condense on to the part.

In exemplary embodiments, applying comprises immersing the part in a reservoir of the chemical in a liquid state.

In exemplary embodiments, applying comprises dispensing the chemical in a liquid or vapour state on to the part via at least one dispending device.

In exemplary embodiments, the powder particles comprise a metal, ceramic, or polymer material resistant to the chemical.

In exemplary embodiments, the binder material comprises a thermoplastic polymer.

In exemplary embodiments, the chemical comprises 1,1,1,3,3,3-hexafluoro-2-propanol (HFIP), dimethylformamide, sulphuric acid, m-cresol, formic acid, trifluoroacetic acid, benzyl alcohol, 1,2,4 trichlorobenzene, tetrahydrofuran, 2-methyltetrahydrofuran, Xylene, or Dimethyl sulfoxide (DMSO).

According to a second aspect of the present invention there is provided use of a chemical to at least soften a binder material supporting unprocessed powder particles at a stepped surface of an additively manufactured part and allow the powder particles at the surface to flow under the influence of gravity into recesses defined by the stepped surface to thereby reduce a roughness of the surface.

In exemplary embodiments, the powder particles comprise a metal, ceramic, or polymer material resistant to the liquid.

According to a third aspect of the present invention there is provided apparatus for smoothing a stepped surface of an additively manufactured part, comprising:
a chamber for containing a chemical in a liquid or vapour state and an additively manufactured part; and
a dispensing device for controllably introducing a predetermined amount the chemical into the chamber to immerse the part in the chemical to at least soften a binder material supporting unprocessed powder particles at a stepped surface of the part and allow the powder particles at the surface to flow under the influence of gravity into recesses defined by the stepped surface to thereby reduce a roughness of the surface.

In exemplary embodiments, the dispensing device comprises a plurality of nozzles located inside the chamber for spraying the chemical in a liquid or vapour state at the part.

In exemplary embodiments, the dispensing device comprises a heater element for vaporising the chemical in a liquid state and a perforated support member located above the heater element for supporting the part thereon.

### DESCRIPTION OF THE DRAWINGS

Certain embodiments of the present invention will now be described with reference to the accompanying drawings in which:

FIG. 1a illustrates bound metal particles forming a stepped surface of an additively manufactured metal part before post-processing;

FIG. 1b illustrates the metal particles of FIG. 1b after post-processing according to certain embodiments of the present invention;

FIG. 2 shows a flow diagram to illustrate a post-processing method according to certain embodiments of the present invention for smoothing an additively manufactured metal part;

FIG. 3a illustrates an embodiment of the present invention wherein the chemical is applied in a vapor phase to a part;

FIG. 3b illustrates an alternative embodiment of the present invention wherein the chemical is applied in a liquid phase to a part, and

FIG. 3c illustrates an alternative embodiment of the present invention wherein the chemical is applied as a liquid to a part via sprinklers/atomiser.

### DETAILED DESCRIPTION

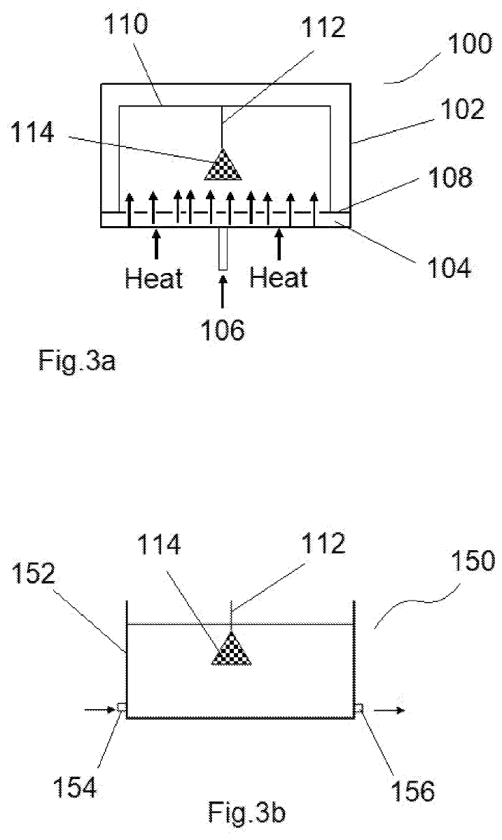

FIG. 2 illustrates a post-processing method according to certain embodiments of the present invention for smoothing an additively manufactured (AM) metal part. The process is applied to the AM part when the same is in its “green state”, i.e. after the part has been printed but before the metal powder has been sintered which is being held in shape by a polymer matrix, such as Polypropylene (PP) or the like.

As step S202 of the method, a chemical, such as a solvent, acid, ionic liquid or other component, suitable to soften/dissolve the polymer acting as a binder is applied to the surface/s of the AM part. Examples of suitable chemicals include, but are not limited, to 1,1,1,3,3,3-hexafluoro-2-propanol (HFIP), dimethylformamide, sulphuric acid, m-cresol, formic acid, trifluoroacetic acid, benzyl alcohol, 1,2,4 trichlorobenzene, tetrahydrofuran, 2-methyltetrahydrofuran, Xylene and Dimethyl sulfoxide (DMSO), or the like. The chemical is selected such that the metal or other material powder particles are resistant to the solvent, i.e. do not react to the chemical.

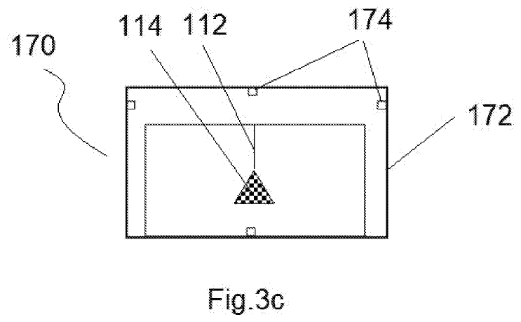

There are a number of ways the chemical may be applied to the surface of the part at the step S202. Aptly, the chemical may be vaporised using a hot plate or other suitable device and then condensed on to the AM part. As illustrated in FIG. 3a, the apparatus 100 according to certain embodiments of the present invention includes a chamber 102, made out of stainless steel or other chemically inert/resistant material. The chamber 102 may be airtight to be able to hold a vacuum. Under the chamber 102, there are one or more heating elements (not shown) to apply heat to a liquid chemical and increase a temperature of the liquid chemical by a predetermined amount to thereby vaporise the liquid chemical. The liquid chemical may be introduced into a plenum 104 via an inlet pipe 106 and vaporised therein. Alternatively, the chemical may be vaporised at the top and/or sides of the chamber and/or in a separate chamber before being introduced into the processing chamber 102. The apparatus 100 also includes a perforated wall 108, made out of stainless steel or other thermally and chemically resistive material. The perforated wall 108 separates the heated part of the chamber where the chemical is vaporised from the rest of the chamber to prevent the part 114 falling onto the liquid chemical, yet still allowing the vaporised chemical to be easily transferred to the chamber 102. The perforated wall 108 thereby defines the plenum 104. The apparatus 100 also includes a rack 110 made out of stainless steel or other chemically inert/resistant material to support the parts 114 using clips/hooks 112, for example.

Optionally, the chamber 102 may have heated walls reaching temperatures up to around 70° C. Optionally, the apparatus 100 may contain a vacuum pump to be able to reduce a pressure in the chamber 102 and cause the chemical vapour to condense on to the part. Aptly, the part/s may be cooled to create an energy potential between the part and the chemical vapour and thereby cause the vaporised chemical to condense on to the part.

The applied chemical may alternatively be applied to the part/s in the liquid phase in which case the part would be immersed in a reservoir, such as a bath, flask, chamber or the like, containing a suitable chemical. As illustrated in FIG. 3b, apparatus 150 according to certain embodiments of the present invention includes a reservoir 152, such as a bath or chamber, for holding a liquid chemical. The reservoir 152 is preferably made from stainless steel or other chemically inert/resistant material. The liquid chemical is allowed into the chamber by an inlet 154 and discharged after the process from an outlet 156. The part 114 may be supported in the chemical by a rack, hook or clip 112 or the like.

Alternatively, the chemical in a liquid or vapour state may be sprayed on to the part using a suitable nozzle/s, sprinkler/s, nebuliser/s, or other suitable dispensing device/s. As illustrated in FIG. 3c, apparatus 170 according to certain embodiments of the present invention includes a chamber 172 preferably made out of stainless steel or other chemically inert/resistant material having a plurality of nozzles/atomisers 174 for spraying chemical onto the part/s 114. Six nozzles are aptly provided in the illustrated example, wherein one nozzle is located on each respective inner surface of the chamber to efficiently apply the chemical vapour on all surfaces of the part/s. The part 114 may be supported in the chemical by a rack, hook or clip or the like.

Aptly, the part/s is located in a chamber during the de-binding process which may be the same chamber as the part/s was printed in or a different chamber.

At step S204, the solvent, acid, ionic liquid or other chemical, dissolves/softens the polymer otherwise binding the metal powder together at the part's surface/s. The polymer softens just enough to allow the binding material to re-flow under the influence of gravity at the surface carrying metal powder particles with it.

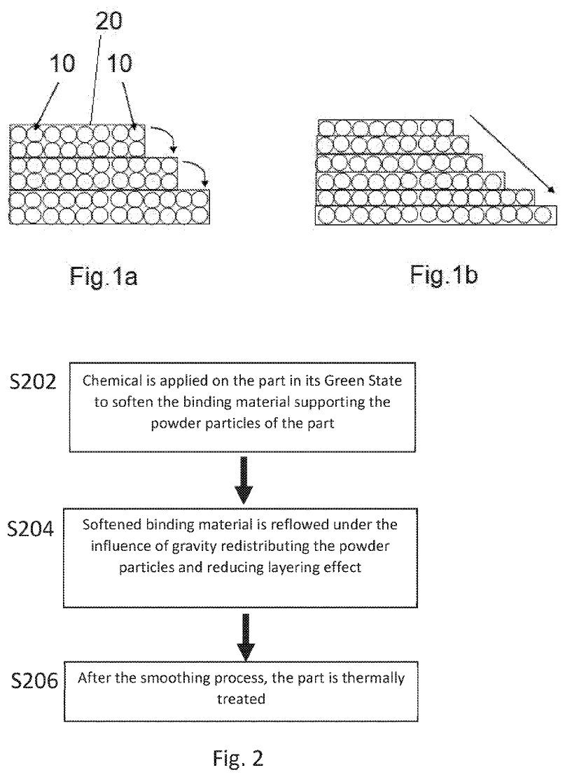

In other words, the chemical allows the polymer binder material 20, and the metal particles 10 being carried by the binder material, to flow into and at least partially fill the stepped ‘recesses’ otherwise defined by the layering effect of the printing process (see arrows in FIG. 1a). As a result, the stepped layering effect is desirably reduced as illustrated in FIG. 1b which in turn reduces the roughness of the part surface/s and minimises any potential notch effects otherwise caused by the undesirable stepped surface/s of the part which were present before the smoothing process.

The amount of binder material softened and caused to re-flow, and in turn the final smoothness of the part, directly correlates to several parameters: contact time between the chemical and the part surface, type/strength/concentration of the chemical applied, method of application (condensing vapour or liquid immersion), and conditions of the method (temperature of the vapour/liquid and/or pressure of the system in case of the vapour method). The surface smoothness relationship can therefore be expressed by the following equation:

S=t×C×M×P

wherein S is the smoothness of the part (μ), t is the contact time between the chemical and the part (seconds), C is the constant adjusting for the type of chemical applied, M is the constant adjusting for the type of method, and P is the constant adjusting for the process parameters.

Optionally, after the smoothing process, the part is dried to remove any residual chemical or chemical trace from the part. The drying temperature is higher than the chemical boiling temperature but lower than the material melting temperature.

At step S206, the part undergoes thermal treatment to sinter the metal powder after the smoothing process. During sintering, the polymer binder material is vaporised out, whereas the metal powder is fused together to give the AM part its final shape. The resulting surface roughness of the final part is much improved because the layering/stepped effect has been desirably reduced during the smoothing process.

Certain embodiments of the present invention therefore provide a method of efficiently smoothing the surface/s of an additively manufactured metal part to improve the appearance of the part and to reduce its surface roughness and any potential notch effects otherwise caused by the rough, stepped surface/s of a conventional AM metal part which can undesirably lead to fatigue and fracture. A relatively smooth outer surface is also desirable for certain applications, particularly in the medical industry, where the potential for bacteria growth on the part must be kept to a minimum. The smoothing process according to certain embodiments of the present invention may also be applied to parts which have been additively manufactured from non-metal powder which is resistant to the chemical used to dissolve the binder, such as a glass, ceramic or polymer-based powder.

1. A method for smoothing a surface of an additively manufactured metal part, comprising:
a) applying a chemical to a stepped surface of an additively manufactured part to at least soften a binder material supporting unprocessed powder particles of the part; and
b) allowing the powder particles at the surface to flow under the influence of gravity into recesses defined by the stepped surface to thereby reduce a roughness of the surface.

2. The method according to claim 1, further comprising:
c) after step b), allowing the binder material to cure and support the powder particles at the surface of the part; and
d) after step c), sintering the part to fuse the powder particles of the part together, and wherein, during sintering, the binder material is vaporised and removed from the part.

3. The method according to claim 1, comprising allowing the binder material to cure and support the powder particles at the surface.

4. The method according to claim 3, comprising thermally treating the part to remove the binder material from the part.

5. The method according to claim 4, wherein thermally treating comprises vaporising the binder material.

6. The method according to claim 1, comprising sintering the part to fuse the powder particles together.

7. The method according to claim 1, comprising drying the part to remove the chemical from the surface.

8. The method according to claim 1, wherein applying comprises vaporising the chemical and condensing the chemical on to the surface of the part.

9. The method according to claim 8, wherein vaporising comprises heating the chemical in a liquid state to a predetermined temperature.

10. The method according to claim 8, wherein condensing comprises creating an energy potential between the part and the vaporised chemical.

11. The method according to claim 10, comprising cooling the part to create the energy potential and cause the vaporised chemical to condense on to the part.

12. The method according to claim 1, wherein applying comprises immersing the part in a reservoir of the chemical in a liquid state.

13. The method according to claim 1, wherein applying comprises dispensing the chemical in a liquid or vapour state on to the part via at least one dispending device.

14. The method according to claim 1, wherein the powder particles comprise a metal, ceramic, or polymer material resistant to the chemical.

15. The method according to claim 1, wherein the binder material comprises a thermoplastic polymer.

16. The method according to claim 1, wherein the chemical comprises 1,1,1,3,3,3-hexafluoro-2-propanol (HFIP), dimethylformamide, sulphuric acid, m-cresol, formic acid, trifluoroacetic acid, benzyl alcohol, 1,2,4 trichlorobenzene, tetrahydrofuran, 2-methyltetrahydrofuran, Xylene, or Dimethyl sulfoxide (DMSO).

17. Use of a chemical to at least soften a binder material supporting unprocessed powder particles at a stepped surface of an additively manufactured part and allow the powder particles at the surface to flow under the influence of gravity into recesses defined by the stepped surface to thereby reduce a roughness of the surface, and optionally wherein the powder particles comprise a metal, ceramic, or polymer material resistant to the liquid.

18. Apparatus for smoothing a stepped surface of an additively manufactured part, comprising:
a chamber for containing a chemical in a liquid or vapour state and an additively manufactured part; and
a dispensing device for controllably introducing a predetermined amount the chemical into the chamber to immerse the part in the chemical to at least soften a binder material supporting unprocessed powder particles at a stepped surface of the part and allow the powder particles at the surface to flow under the influence of gravity into recesses defined by the stepped surface to thereby reduce a roughness of the surface.

19. The apparatus according to claim 18, wherein the dispensing device comprises a plurality of nozzles located inside the chamber for spraying the chemical in a liquid or vapour state at the part.

20. The apparatus according to claim 18, wherein the dispensing device comprises a heater element for vaporising the chemical in a liquid state and a perforated support member located above the heater element for supporting the part thereon.
